(19) United States
(12) Patent Application Publication
(10) Pub. No.: US 2020/0350153 A1
(43) Pub. Date: Nov. 5, 2020

(54) MASS SPECTROMETER

(71) Applicant: Shimadzu Corporation, Kyoto-shi (JP)

(72) Inventor: Kei KODERA, Kyoto-shi (JP)

(73) Assignee: Shimadzu Corporation, Kyoto-shi (JP)

(21) Appl. No.: 16/398,964

(22) Filed: Apr. 30, 2019

(51) Int. Cl. H01J 49/42; H01J 49/00; H01J 43/10

(52) U.S. Cl. CPC H01J 49/423; H01J 43/10; H01J 49/0063; H01J 49/427

(57) ABSTRACT

Conversion dynodes (CDs) 31 and 32 are respectively provided for ion-ejection ports 21a and 22a facing each other across the central axis C of a linear ion trap (LIT) 2. A shield plate 34 having ion-passage openings 34a is provided between LIT and CDs. A voltage slightly lower than the voltage applied to CDs is applied to the shield plate. Ions ejected from LIT by resonant excitation are accelerated by an electric field between LIT and the shield plate, having their trajectories gradually curved, to eventually reach CDs through the ion-passage openings. Upon receiving the ions, CDs emit electrons. Some electrons may initially move toward the shielding plate, but will be repelled to and detected by an electron multiplier tube 33. CDs can be made of aluminum or similar inexpensive materials, which reduces the cost as well as eliminates the loss of the ions and improves detection sensitivity.

### TECHNICAL FIELD

The present invention relates to a mass spectrometer, and more specifically, to a linear ion trap mass spectrometer including a linear ion trap for holding ions inside and a detector for detecting ions ejected from the linear ion trap.

### BACKGROUND ART

A mass spectrometer employing an ion trap for holding ions by means of an electric field has been commonly known as one type of mass spectrometer. Ion traps are roughly divided into a three-dimensional quadrupole ion trap and a linear ion trap. Linear ion traps normally include four rod electrodes which are arranged substantially parallel to each other so as to surround a central axis, as well as a pair of end electrodes (end-cap electrodes) respectively located on the outside of the two end faces of those rod electrodes (see Patent Literature 1 or 2). When ions are to be held within the inner space of the linear ion trap, predetermined radio-frequency voltages are respectively applied to the four rod electrodes, while a direct voltage having the same polarity as the ions is applied to the pair of end electrodes. Ions are thereby captured within a comparatively large space extending along the central axis in the linear ion trap.

In such a linear ion trap, it is often the case that ions are introduced through an opening formed in one or both of the end electrodes into the space surrounded by the rod electrodes, and held within the inner space. In order to detect the ions held within the inner space while separating those ions from each other according to their mass-to-charge ratios, the frequency or amplitude of the radio-frequency voltages applied to the rod electrodes is controlled so as to resonantly excite ions having a specific mass-to-charge ratio to be detected. The excited ions are ejected to the outside through an ion-ejection port formed in the rod electrodes. An ion detector, which is placed on the outside of the ion-ejection port, generates a detection signal according to the number of ions which have reached the ion detector.

A typical method for ejecting the ions is the dipole resonant excitation. In this method, the ions are significantly excited in opposite directions which are both substantially orthogonal to the central axis of the linear ion trap. In order to detect the resonantly excited ions with no significant loss of the ions, it is necessary to provide an ion-ejection port in each of the rod electrodes at locations facing each other across the central axis, and place an ion detector on the outside of each of the two ion-ejection ports, with each ion detector including the combination of a conversion dynode for converting ions into electrons and an electron multiplier tube for detecting those ions after multiplying them. The mass spectrometer disclosed in Patent Literature 1 has such a configuration. With such a configuration, ions can be detected with no significant loss, so that a high level of detection sensitivity can be achieved. However, ion detectors, and particularly, electron multiplier tubes are expensive. Therefore, the provision of the two ion detectors inevitably increases the cost of the device.

On the other hand, the mass spectrometer described in Patent Literature 2 has an ion-ejection port at a single location in the rod electrodes, with one ion detector placed on the outside of that single ion-ejection port. This configuration requires only one ion detector and thereby allows for the cost reduction of the device. However, roughly one half of the entire amount of resonantly excited ions remain unused for the detection and are wasted. Therefore, in terms of the detection sensitivity, this device is considerably inferior to the configuration which employs two ion detectors.

### CITATION LIST

### Patent Literature

Patent Literature 1: U.S. Pat. No. 6,797,950 B

Patent Literature 2: JP 2012-184975 A

### SUMMARY OF INVENTION

### Technical Problem

Thus, in the conventional type of linear ion trap mass spectrometer, it is inevitable to sacrifice the detection sensitivity in order to reduce the cost of the device. The present invention has been developed to solve such a problem. Its objective is to provide a linear ion trap mass spectrometer which allows for the cost reduction of the device and yet can achieve a high level of detection sensitivity.

### Solution to Problem

The mass spectrometer according to the present invention developed for solving the previously described problem includes:

a) a linear ion trap including a plurality of rod electrodes arranged substantially parallel to each other around a central axis, the linear ion trap having a plurality of ion-ejection ports for ejecting ions from an internal space surrounded by the rod electrodes to the outside;

b) a plurality of conversion dynodes respectively provided for the plurality of ion-ejection ports of the linear ion trap, with each conversion dynode configured to emit electrons upon receiving ions ejected through the corresponding ion-ejection port;

c) a shield plate located between the linear ion trap and the plurality of conversion dynodes, the shield plate having a plurality of ion-passage openings for allowing ions ejected through the plurality of ion-ejection ports of the linear ion trap to pass through;

d) a common detector section located on the same side as the plurality of conversion dynodes with respect to the shield plate, the detector section configured to receive electrons emitted from the plurality of conversion dynodes and produce a detection signal corresponding to the amount of those electrons; and

e) a voltage-applying section configured to apply, to the shield plate, a voltage for attracting ions ejected through the plurality of ion-ejection ports of the linear ion trap, and apply, to the plurality of conversion dynodes, a voltage equal to or higher than the voltage applied to the shield plate, as well as apply, to the detector section, a voltage higher than the voltage applied to the plurality of conversion dynodes.

In the mass spectrometer according to the present invention, a plurality of ion-ejection ports are provided in the rod electrodes constituting the linear ion trap to allow for the ejection of ions from the inner space to the outside by resonance excitation. Typically, as in the mass spectrometer described in Patent Literature 1, a total of two ion-ejection ports may be provided on a straight line which orthogonally intersects with the central axis of the linear ion trap, with one ion-ejection port on either side of the central axis. The same number of conversion dynodes as the ion-ejection ports are placed on the outside of the linear ion trap, with one conversion dynode corresponding to each ion-ejection port. Meanwhile, there is only a single detector section for detecting ions ejected from the conversion dynodes in response to the incidence of ions; i.e., the detector section is shared by the plurality of conversion dynodes.

However, the sharing of the same detector section by the plurality of conversion dynodes which are located separately from one another makes it difficult to place each conversion dynode at a close position to the electron-receiving surface in the detector section. Therefore, the percentage of the electrons emitted from the conversion dynodes and reaching the electron-receiving surface in the detector section tends to be low. In particular, the conversion dynodes are normally supplied with a voltage which causes ions ejected from the linear ion trap to be attracted toward the conversion dynodes; for example, when the analysis target is a positive ion, a voltage which is lower than the voltage applied to the linear ion trap is applied to the conversion dynodes. Consequently, the electrons emitted from the conversion dynodes experience a force opposite to the force acting on the ions, i.e. a force which tends to make the electrons move toward the linear ion trap. To address this problem, a shield plate is located between the linear ion trap and the conversion dynodes in the mass spectrometer according to the present invention. A voltage equal to or lower than the voltage applied to the conversion dynodes is applied to the shield plate (if the voltages have a negative polarity, the former voltage has a larger absolute value than the latter). Additionally, a voltage which is higher than the voltage applied to the conversion dynodes, i.e. a voltage which attracts electrons, is applied to the detector section.

Due to the voltage applied to the shield plate in the previously described manner, an electric field which accelerates ions ejected from the linear ion trap toward the shield plate is created within the space between the shield plate and the linear ion trap. Most of the ions accelerated by this electric field pass through the ion-passage openings formed at appropriate positions in the shield plate, and reach the conversion dynodes. An electric field which makes electrons emitted from the conversion dynode move toward the detector section is created within the space between each conversion dynode and the detector section. By comparison, the electric field created between each conversion dynode and the shield plate does not have the effect of making the electrons emitted from the conversion dynode move toward the shield plate, or the electric field conversely has the effect of pushing the electrons back to the conversion dynode. Therefore, the electrons emitted from the conversion dynode in response to the incidence of ions travel toward the detector section, and a high percentage of the electrons will reach and be detected by the detector section.

Thus, in the mass spectrometer according to the present invention, even if there is a certain distance between the detector section and the conversion dynodes by which ions ejected from the inner space of the linear ion trap through the ion-ejection ports are each converted into electrons, the electrons emitted from the conversion dynodes can be efficiently collected into and detected by the common detector section.

In the mass spectrometer according to the present invention, the voltage-applying section may preferably be configured to apply, to each of the plurality of conversion dynodes, a voltage which is higher than the voltage applied to the shield plate.

By this configuration, the electrons emitted from the conversion dynode toward the shield plate can be pushed back by the effect of an electric field, so that the percentage of the electrons reaching the detector section can be further increased. However, the difference in potential between the shield plate and the conversion dynodes must not be too large, otherwise the ions traveling toward the conversion dynodes after passing through the openings of the shield plate may possibly be pushed back to the shield plate due to the effect of the electric field created within the space between the shield plate and the conversion dynodes. Accordingly, the difference in potential between the shield plate and the conversion dynodes should be set to be appropriately small so that the low-mass electrons will be pushed back due to the potential difference while the ions having higher masses than the electrons will be insignificantly affected by it.

The mass spectrometer according to the present invention may preferably be configured as follows: the plurality of ion-ejection ports are located so as to face each other across the central axis of the linear ion trap; and the plurality of ion-passage openings in the shield plate, the plurality of conversion dynodes, and the common detector section are arranged at positions which are plane-symmetrical with respect to a symmetry plane of the plurality of ion-ejection ports, with the symmetry plane containing the central axis of the linear ion trap.

With this configuration, the electric field within the spaces on both sides of the symmetry plane of the ion-ejection ports becomes symmetrical, so that the trajectories which the ions ejected from the ion-ejection ports follow until they reach the detector section will also be approximately symmetrical. Accordingly, once the arrangement of the relevant elements and the applied voltages within the space on one side of the symmetry plane have been optimized, the same arrangement and applied voltages can also be applied in the space on the other side. This facilitates the designing of the device as well as leads to a reduction in the manufacturing cost.

### Advantageous Effects of Invention

In the mass spectrometer according to the present invention, the required number of conversion dynodes can be combined with fewer ion detectors, which are far more complex in structure and expensive than the conversion dynodes. Therefore, the cost of the device will be lower than in the case where the conversion dynodes are combined with the same number of ion detectors. The ions resonantly excited in the linear ion trap will be almost entirely ejected through the ion-ejection ports and be eventually detected with no significant loss, so that a high level of detection sensitivity will be achieved.

### BRIEF DESCRIPTION OF DRAWINGS

FIG. 1 is a schematic configuration diagram of a linear ion trap mass spectrometer as one embodiment of the present invention.

FIG. 2 is a schematic plan view of the linear ion trap in FIG. 1.

FIG. 3 is a conceptual diagram showing the state of the potential at relevant sections between the linear ion trap and an electron multiplier tube.

FIG. 4 is a graphic image showing the result of a simulation of the trajectories of ions and electrons.

### DESCRIPTION OF EMBODIMENTS

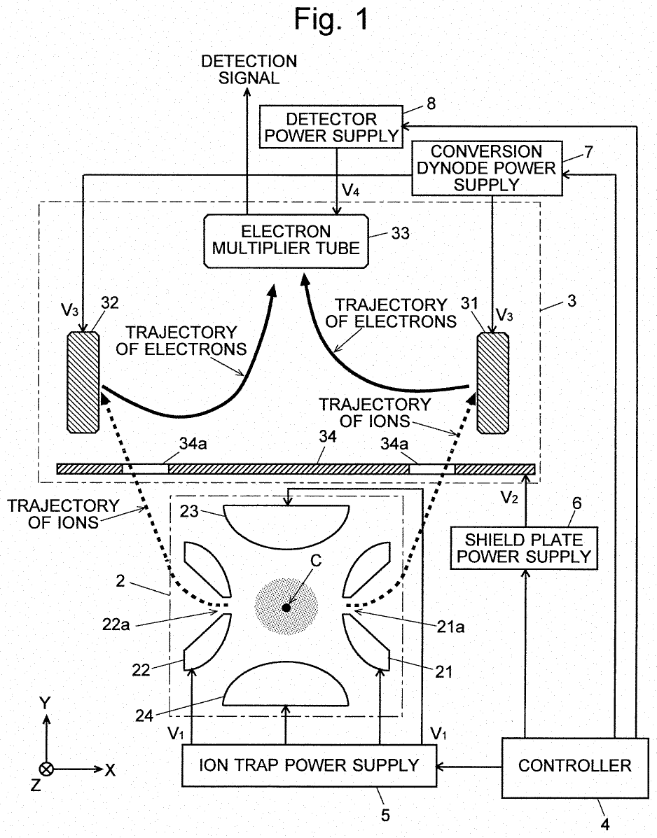

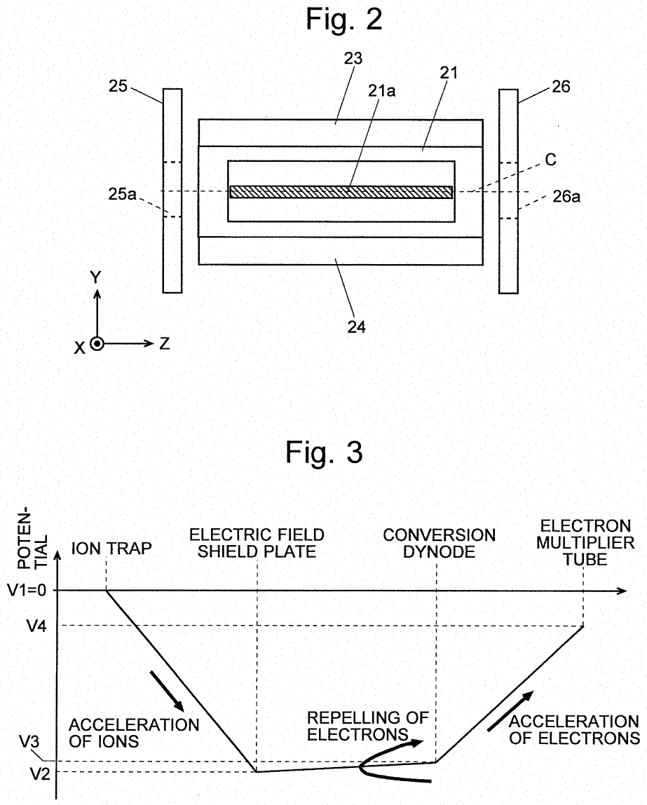

A linear ion trap mass spectrometer as one embodiment of the present invention is hereinafter described with reference to the attached drawings. FIG. 1 is a schematic configuration diagram of the linear ion trap mass spectrometer according to the present embodiment. FIG. 2 is a schematic plan view of the linear ion trap in FIG. 1 (with the X axis orthogonally directed to the plane of the drawing).

The ion source for generating ions to be analyzed is not shown in FIG. 1. The linear ion trap mass spectrometer according to the present embodiment includes the ion source (not shown), a linear ion trap 2, an ion detector section 3, a controller 4, an ion trap power supply 5, a shield plate power supply 6, a conversion dynode power supply 7 and a detector power supply 8.

The linear ion trap 2 includes four rod electrodes 21, 22, 23 and 24 arranged parallel to each other around a central axis C extending in the Z-axis direction in FIG. 1 (i.e. the direction which is orthogonal to the plane of the drawing), with their inner surfaces being hyperbolic in cross-section. In FIG. 1, the linear ion trap 2 is shown by an end view of the rod electrodes 21, 22, 23 and 24 sectioned at a plane perpendicular to the central axis C (X-Y plane). As shown in FIG. 2, the two rod electrodes 21 and 22 facing one another across the central axis C have slit-like ion-ejection ports 21a and 22a extending in the Z-axis direction, respectively. Two end electrodes 25 and 26 having a substantially circular shape are located on the outside of the two ends of the rod electrodes 21, 22, 23 and 24 in such a manner that the rod electrodes 21, 22, 23 and 24 are sandwiched between the end electrodes. Ion-introduction ports 25a and 26a in the form of a circle centered on the central axis C are formed in the end electrodes 25 and 26, respectively.

The ion detector section 3 includes: two conversion dynodes 31 and 32 provided for the two ion-ejection ports 21a and 22a of the linear ion trap 2, respectively; a common electron multiplier tube 33 for receiving electrons emitted from the conversion dynodes 31 and 32; and a shield plate 34 located between the linear ion trap 2 and the conversion dynodes 31 and 32. The shield plate 34 is a plate-shaped electrically conductive member, in which ion-passage openings 34a are formed at appropriate positions to allow for the passage of ions traveling from the ion-ejection ports 21a and 22a toward the corresponding conversion dynodes 31 and 32. As shown in FIG. 1, the two ion-passage openings 34a formed in the shield plate 34, the two conversion dynodes 31 and 32 as well as the single common electrode multiplier tube 33 are plane-symmetrically arranged with respect to the symmetry plane of the two ion-ejection ports 21a and 22a containing the central axis C of the linear ion trap 2. The conversion dynodes 31 and 32 are made of an electrically conductive material, such as aluminum. Aluminum is commonly used because the aluminum oxide formed on the aluminum surface yields a high level of ion-to-electron conversion efficiency which is second only to the alkaline metal, and also because aluminum is inexpensive as well as easy to handle.

Under the control of the controller 4, the ion trap power supply 5 applies predetermined voltages to the rod electrodes 21, 22, 23 and 24 as well as the end electrodes 25 and 26, respectively. The shield plate power supply 6 applies a predetermined direct voltage V₂ to the shield plate 34. The conversion dynode power supply 7 applies a predetermined direct voltage V₃ to each of the conversion dynodes 31 and 32. The detector power supply 8 applies a predetermined direct voltage V₄ to the electron multiplier tube 33.

A mass spectrometric operation in the mass spectrometer according to the present embodiment is hereinafter described with reference to an example in which the ions to be analyzed are positive ions

Ions generated by the ion source (not shown) are introduced through one or both of the ion-introduction ports 25a and 26a into the inner space surrounded by the rod electrodes 21, 22, 23 and 24. The introduced ions are captured by a quadrupole electric field formed by the radio-frequency voltages applied from the ion trap power supply 5 to the rod electrodes 21, 22, 23 and 24. When the ions introduced into the inner space are to be captured, a direct voltage for repelling the ions is applied to the end electrodes 25 and 26, whereby the ions are confined within the inner space (an elongated space extending in the Z-axis direction) surrounded by the rod electrodes 21, 22, 23 and 24.

When an ion having a specific mass-to-charge ratio M is to be separated from the other ions and detected, the controller 4 operates the ion trap power supply 5 to apply a specific radio-frequency voltage corresponding to the mass-to-charge ratio M to the rod electrodes 21, 22, 23 and 24. Then, only the ions having the mass-to-charge ratio M among the various ions captured within the inner space are made to significantly oscillate in a direction along the X axis due to the resonant excitation, to be eventually ejected through the ion-ejection ports 21a and 22a. During this operation, the direct voltage V₁ applied to the rod electrodes 21, 22, 23 and 24 of the linear ion trap 2 is set at 0 V, for example. The direct voltage V₂ applied to the shield plate 34, the direct voltage V₃ applied to the conversion dynodes 31 and 32, as well as the direct voltage V₄ applied to the electron multiplier tube 33 are related to each other as shown in FIG. 3.

That is to say, as in the conventional case, a voltage V₃ for attracting ions is applied to the conversion dynodes 31 and 32. Additionally, a slightly lower voltage V₂ is applied to the shield plate 34. A voltage V₄ which is higher than the voltage V₃ applied to the conversion dynodes 31 and 32 is applied to the electron multiplier tube 33 in order to attract electrons emitted from the conversion dynodes 31 and 32. When the voltages are applied in this manner, an electric field which attracts ions ejected from the ion-ejection ports 21a and 22a toward the shield plate 34 is created within the space between the shield plate 34 and an area near the exit end of the ion-ejection ports 21a and 22a of the linear ion trap 2. Due to the effect of this electric field, the ions ejected substantially parallel to the X axis are accelerated having their trajectories gradually curved as shown by the thick broken lines in FIG. 1. The accelerated ions pass through the ion-passage openings 34a.

As just described, the voltage V₂ applied to the shield plate 34 is lower than the voltage V₃ applied to the conversion dynodes 31 and 32. Therefore, as shown in FIG. 3, a force which repels ions from the conversion dynodes 34 toward the shield plate 34 acts on the ions which have passed through the ion-passage openings 34a. However, since the potential difference between V₂ and V₃ is small, the ion-repelling force is also small, so that the ions which have been sufficiently accelerated by the point in time of the exit from the ion-passage openings 34a have almost no difficulty in reaching the conversion dynodes 31 and 32. Upon being hit by the ions, the conversion dynodes 31 and 32 emit electrons in exchange for the ions. Those electrons are emitted in various directions. Meanwhile, an electric field for accelerating electrons from the conversion dynodes 31 and 32 toward the electron multiplier tube 33 is formed by the voltage V₃ applied to the conversion dynodes 31 and 32 as well as the voltage V₄ applied to the electron multiplier tube 33. Additionally, a weak electric field (with a low potential gradient) producing a force which pushes the electrons emitted from the conversion dynodes 31 and 32 back to the same conversion dynodes 31 and 32 is created within the space between the shield plate 34 and the conversion dynodes 31 and 32. Therefore, most of the electrons emitted from the conversion dynodes 31 and 32 will travel toward the electron multiplier tube 33, as indicated by the thick arrows in FIG. 3. Thus, a high percentage of the electrons will reach and be detected by the electron multiplier tube 33.

The presence of the shield plate 34 also means that the electric field on the side where the conversion dynodes 31 and 32 are located insignificantly affects the electric field on the side where the linear ion trap 2 is located, and vice versa. In other words, the shield plate 34 has the function of blocking the electric fields.

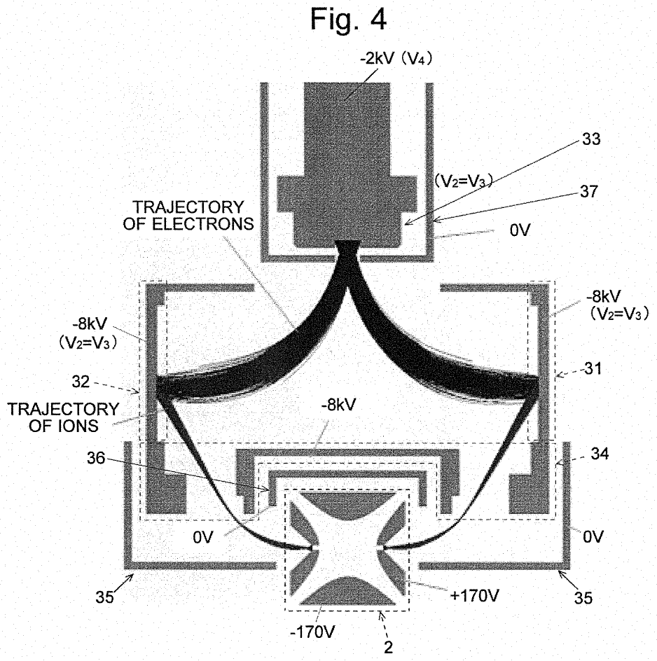

FIG. 4 shows the result of a simulation of the trajectories of ions and electrons. For simplicity of the configuration, the conversion dynodes 31 and 32 in the simulation model are integrated with the shield plate 34 to form a single part, which is maintained at the same potential (−8 kV). Another shield plate 36 having a predetermined potential of 0 V is located between the shield plate 34 and the linear ion trap 2. This shield plate 36 is intended to shield the linear ion trap 2 from the influence of the electric field created by the potential of the shield plate 34. Still another shield plate 35 having an L-shaped cross section surrounding the ion-ejection port 21a or 22a is located on the outside of each of the ion-ejection ports 21a and 22a within the space on the opposite side from the shield plate 34 across the central axis of the ion-ejection ports 21a and 22a. This shield plate 35 is intended to prevent ions ejected from the ion-ejection port 21a or 22a from diffusing toward the side which is opposite from the shield plate 34. There is yet another shield plate 37 surrounding the electron multiplier tube 33. This shield plate 37 limits the area through which electrons can hit the entrance surface of the electron multiplier tube 33. This decreases the amount of electrons (and other kinds of charged particles) different from those emitted from the conversion dynodes 31 and 32 from reaching the entrance surface of the electron multiplier tube 33. Consequently, the amount of noise will be reduced. These shield plates 35, 36 and 37 are dispensable elements, although they are considerably effective in practical situations.

As shown in FIG. 4, the ions ejected from the ion-ejection ports 21a and 22a of the linear ion trap 2 have their trajectories gradually curved immediately after their ejection, and eventually reached the conversion dynodes 31 and 32 after passing through the ion-passage openings 34a. As such, the target ions ejected from the linear ion trap 2 by resonant excitation have successfully reach the conversion dynodes 31 and 32 with no significant loss. The electrons emitted from the conversion dynodes 31 and 32 have also successfully reached the entrance surface of the electron multiplier tube 33, which is almost equidistant from both conversion dynodes 31 and 32, with no significant loss. These results confirm that a detection signal corresponding to a target ion ejected from the linear ion trap 2 can be obtained with a high level of sensitivity by appropriately determining the arrangement and shape of each relevant element, the level of the applied voltages as well as other factors.

It should be noted that the previous embodiment is a mere example of the present invention, and any change, modification or addition appropriately made within the spirit of the present invention will naturally fall within the scope of claims of the present application.

For example, the arrangement of the shield plate 34, conversion dynodes 31 and 32, electron multiplier tube 33 and other elements as well as their respective shapes can be appropriately changed. Furthermore, as noted earlier, any component which should be set at their respective predetermined potentials may be added, as with the shield plates 35, 36 and 37.

### REFERENCE SIGNS LIST

2 . . . Linear Ion Trap
21, 22, 23, 24 . . . Rod Electrode
21a, 22a . . . Ion-Ejection Port
25, 26 . . . End Electrode
25a, 26a . . . Ion-Introduction Port
3 . . . Ion Detector
31, 32 . . . Conversion Dynode
33 . . . Electron Multiplier Tube
34, 35, 36, 37 . . . Shield Plate
34a . . . Ion-Passage Opening
4 . . . Controller
5 . . . Ion Trap Power Supply
6 . . . Shield Plate Power Supply
7 . . . Conversion Dynode Power Supply
8 . . . Detector Power Supply
C . . . Central Axis

1. A mass spectrometer comprising:
a linear ion trap including a plurality of rod electrodes positioned substantially parallel to each other around a central axis, the linear ion trap having a plurality of ion-ejection ports for ejecting ions from an internal space surrounded by the rod electrodes to an outside;
a plurality of conversion dynodes positioned for the plurality of ion-ejection ports in the linear ion trap, respectively, such that each of the conversion dynodes is configured to emit electrons upon receiving ions ejected through a respective one of the ion-ejection ports;
a shield plate positioned between the linear ion trap and the plurality of conversion dynodes and having a plurality of ion-passage openings for allowing ions ejected through the plurality of ion-ejection ports of the linear ion trap to pass through;
a common detector section positioned on a same side as the plurality of conversion dynodes with respect to the shield plate and configured to receive electrons emitted from the plurality of conversion dynodes and produce a detection signal corresponding to an amount of the electrons received from the plurality of conversion dynodes; and
a voltage-applying section comprising circuitry configured to apply, to the shield plate, a voltage which attracts ions ejected through the plurality of ion-ejection ports of the linear ion trap, to apply, to the plurality of conversion dynodes, a voltage equal to or higher than the voltage applied to the shield plate, and to apply, to the common detector section, a voltage higher than the voltage applied to the plurality of conversion dynodes.

2. The mass spectrometer according to claim 1, wherein the voltage-applying section is configured to apply, to each of the plurality of conversion dynodes, a voltage which is higher than the voltage applied to the shield plate.

3. The mass spectrometer according to claim 1, wherein the plurality of ion-ejection ports are positioned to face each other across the central axis of the linear ion trap, and the plurality of ion-passage openings in the shield plate, the plurality of conversion dynodes, and the common detector section are positioned plane-symmetrical with respect to a symmetry plane of the plurality of ion-ejection ports, with the symmetry plane containing the central axis of the linear ion trap.

4. The mass spectrometer according to claim 2, wherein the plurality of ion-ejection ports are positioned to face each other across the central axis of the linear ion trap, and the plurality of ion-passage openings in the shield plate, the plurality of conversion dynodes, and the common detector section are positioned plane-symmetrical with respect to a symmetry plane of the plurality of ion-ejection ports, with the symmetry plane containing the central axis of the linear ion trap.

5. The mass spectrometer according to claim 1, wherein the circuitry of the voltage applying section includes a shield plate power supply configured to apply, to the shield plate, the voltage which attracts the ions ejected through the plurality of ion-ejection ports of the linear ion trap, a conversion dynode power supply configured to apply, to the plurality of conversion dynodes, the voltage equal to or higher than the voltage applied to the shield plate, a detector power supply configured to apply, to the common detector section, the voltage higher than the voltage applied to the plurality of conversion dynodes, and a controller comprising control circuitry configured to control the shield plate power supply, the conversion dynode power supply, and the detector power supply.

6. The mass spectrometer according to claim 1, wherein the circuitry of the voltage applying section includes an ion trap power supply configured to apply, to the plurality of rod electrodes, a voltage, the linear ion trap a shield plate power supply configured to apply, to the shield plate, the voltage which attracts the ions ejected through the plurality of ion-ejection ports of the linear ion trap, a conversion dynode power supply configured to apply, to the plurality of conversion dynodes, the voltage equal to or higher than the voltage applied to the shield plate, a detector power supply configured to apply, to the common detector section, the voltage higher than the voltage applied to the plurality of conversion dynodes, and a controller comprising control circuitry configured to control the ion trap power supply, the shield plate power supply, the conversion dynode power supply, and the detector power supply.

7. The mass spectrometer according to claim 1, wherein the common detector section comprises an electron multiplier tube configured to receive the electrons emitted from the plurality of conversion dynodes and produce the detection signal corresponding to the amount of the electrons received from the plurality of conversion dynodes.

8. The mass spectrometer according to claim 2, wherein the circuitry of the voltage applying section includes a shield plate power supply configured to apply, to the shield plate, the voltage which attracts the ions ejected through the plurality of ion-ejection ports of the linear ion trap, a conversion dynode power supply configured to apply, to the plurality of conversion dynodes, the voltage equal to or higher than the voltage applied to the shield plate, a detector power supply configured to apply, to the common detector section, the voltage higher than the voltage applied to the plurality of conversion dynodes, and a controller comprising control circuitry configured to control the shield plate power supply, the conversion dynode power supply, and the detector power supply.

9. The mass spectrometer according to claim 2, wherein the circuitry of the voltage applying section includes an ion trap power supply configured to apply, to the plurality of rod electrodes, a voltage, the linear ion trap a shield plate power supply configured to apply, to the shield plate, the voltage which attracts the ions ejected through the plurality of ion-ejection ports of the linear ion trap, a conversion dynode power supply configured to apply, to the plurality of conversion dynodes, the voltage equal to or higher than the voltage applied to the shield plate, a detector power supply configured to apply, to the common detector section, the voltage higher than the voltage applied to the plurality of conversion dynodes, and a controller comprising control circuitry configured to control the ion trap power supply, the shield plate power supply, the conversion dynode power supply, and the detector power supply.

10. The mass spectrometer according to claim 2, wherein the common detector section comprises an electron multiplier tube configured to receive the electrons emitted from the plurality of conversion dynodes and produce the detection signal corresponding to the amount of the electrons received from the plurality of conversion dynodes.

11. The mass spectrometer according to claim 3, wherein the circuitry of the voltage applying section includes a shield plate power supply configured to apply, to the shield plate, the voltage which attracts the ions ejected through the plurality of ion-ejection ports of the linear ion trap, a conversion dynode power supply configured to apply, to the plurality of conversion dynodes, the voltage equal to or higher than the voltage applied to the shield plate, a detector power supply configured to apply, to the common detector section, the voltage higher than the voltage applied to the plurality of conversion dynodes, and a controller comprising control circuitry configured to control the shield plate power supply, the conversion dynode power supply, and the detector power supply.

12. The mass spectrometer according to claim 3, wherein the circuitry of the voltage applying section includes an ion trap power supply configured to apply, to the plurality of rod electrodes, a voltage, the linear ion trap a shield plate power supply configured to apply, to the shield plate, the voltage which attracts the ions ejected through the plurality of ion-ejection ports of the linear ion trap, a conversion dynode power supply configured to apply, to the plurality of conversion dynodes, the voltage equal to or higher than the voltage applied to the shield plate, a detector power supply configured to apply, to the common detector section, the voltage higher than the voltage applied to the plurality of conversion dynodes, and a controller comprising control circuitry configured to control the ion trap power supply, the shield plate power supply, the conversion dynode power supply, and the detector power supply.

13. The mass spectrometer according to claim 3, wherein the common detector section comprises an electron multiplier tube configured to receive the electrons emitted from the plurality of conversion dynodes and produce the detection signal corresponding to the amount of the electrons received from the plurality of conversion dynodes.

14. The mass spectrometer according to claim 4, wherein the circuitry of the voltage applying section includes a shield plate power supply configured to apply, to the shield plate, the voltage which attracts the ions ejected through the plurality of ion-ejection ports of the linear ion trap, a conversion dynode power supply configured to apply, to the plurality of conversion dynodes, the voltage equal to or higher than the voltage applied to the shield plate, a detector power supply configured to apply, to the common detector section, the voltage higher than the voltage applied to the plurality of conversion dynodes, and a controller comprising control circuitry configured to control the shield plate power supply, the conversion dynode power supply, and the detector power supply.

15. The mass spectrometer according to claim 4, wherein the circuitry of the voltage applying section includes an ion trap power supply configured to apply, to the plurality of rod electrodes, a voltage, the linear ion trap a shield plate power supply configured to apply, to the shield plate, the voltage which attracts the ions ejected through the plurality of ion-ejection ports of the linear ion trap, a conversion dynode power supply configured to apply, to the plurality of conversion dynodes, the voltage equal to or higher than the voltage applied to the shield plate, a detector power supply configured to apply, to the common detector section, the voltage higher than the voltage applied to the plurality of conversion dynodes, and a controller comprising control circuitry configured to control the ion trap power supply, the shield plate power supply, the conversion dynode power supply, and the detector power supply.

16. The mass spectrometer according to claim 4, wherein the common detector section comprises an electron multiplier tube configured to receive the electrons emitted from the plurality of conversion dynodes and produce the detection signal corresponding to the amount of the electrons received from the plurality of conversion dynodes.

17. The mass spectrometer according to claim 5, wherein the common detector section comprises an electron multiplier tube configured to receive the electrons emitted from the plurality of conversion dynodes and produce the detection signal corresponding to the amount of the electrons received from the plurality of conversion dynodes.

18. The mass spectrometer according to claim 6, wherein the common detector section comprises an electron multiplier tube configured to receive the electrons emitted from the plurality of conversion dynodes and produce the detection signal corresponding to the amount of the electrons received from the plurality of conversion dynodes.

19. The mass spectrometer according to claim 1, wherein the circuitry of the voltage applying section includes a shield plate power supply configured to apply, to the shield plate, the voltage which attracts the ions ejected through the plurality of ion-ejection ports of the linear ion trap, a conversion dynode power supply configured to apply, to the plurality of conversion dynodes, the voltage higher than the voltage applied to the shield plate, a detector power supply configured to apply, to the common detector section, the voltage higher than the voltage applied to the plurality of conversion dynodes, and a controller comprising control circuitry configured to control the shield plate power supply, the conversion dynode power supply, and the detector power supply.

20. The mass spectrometer according to claim 2, wherein the circuitry of the voltage applying section includes a shield plate power supply configured to apply, to the shield plate, the voltage which attracts the ions ejected through the plurality of ion-ejection ports of the linear ion trap, a conversion dynode power supply configured to apply, to the plurality of conversion dynodes, the voltage higher than the voltage applied to the shield plate, a detector power supply configured to apply, to the common detector section, the voltage higher than the voltage applied to the plurality of conversion dynodes, and a controller comprising control circuitry configured to control the shield plate power supply, the conversion dynode power supply, and the detector power supply.
